(19) United States
(12) Patent Application Publication
(10) Pub. No.: US 2011/0156383 A1
(43) Pub. Date: Jun. 30, 2011

(54) CONNECTION PIECE

(75) Inventors: Urs BOBST, Kestenholz (CH); Markus Graf, Thurnen (CH); Andreas Naef, Aarau (CH); Patrik Zeiter, Riken (CH); Thomas Wullschleger, Herzogenbuchsee (CH); Peter Schindler, Trogen (CH); Kurt Gysin, Buckten (CH)

(73) Assignee: R. Nussbaum AG, Olten (CH)

(21) Appl. No.: 12/650,223

(22) Filed: Dec. 30, 2009

(51) Int. Cl. F16L 55/00

(52) U.S. Cl. 285/24

(57) ABSTRACT

A connection piece (111) for a plug-in connection of a fluid-carrying system of lines for distributing drinking water within stories is formed without a supporting nipple. The connection piece (111) has in the region of an inner lateral surface of the first tubular part a first peripheral guiding surface (122) and a second peripheral guiding surface (117), arranged behind the first guiding surface (122) with respect to an insertion opening of the connection piece (111), for the second tubular part (160). A first axial extent of the first guiding surface (122) and a second axial extent of the second guiding surface (117) respectively make up each at least one sixth of an inside diameter of the first tubular part (112, 120). The connection piece (111) may form part of a fitting or a faucet and is suitable in particular for use with solid plastic pipes, for example of crosslinked polyethylene.

### TECHNICAL FIELD

The invention relates to a connection piece with a first tubular part, which can be connected in a fluid-tight manner to a second tubular part of a fluid-carrying system of lines for the distribution of drinking water, wherein the connection piece is formed in such a way that, in the connected state, the second tubular part is partially enclosed by the first tubular part, wherein a peripheral recess in which an annular sealing element is received is made in the first tubular part, on an inner lateral surface contacting the second tubular part in the connected state, and wherein the connection piece is formed in such a way that the second tubular part can be connected to the first tubular part in the sense of a plug-in connection by pushing it into the first part in a pushing-in direction. The invention also relates to a fitting and a faucet with such a connecting piece as well as an arrangement for the distribution of hot and cold water.

### PRIOR ART

Fluid-carrying systems of lines, in particular for water or aqueous solutions, are usually made up of a number of elements (pipes, connecting pieces or fittings, valve-type fittings, etc.). These elements usually have connection pieces with tubular parts, wherein the tubular parts can be connected to corresponding tubular parts of the connection pieces of neighboring elements. In order that the connection is tight, i.e. in order that an escape of the liquid carried in the system of lines is prevented at the connecting points, the latter are provided with seals. In the case of many systems of lines, for example for supplying water (including distribution to householders), a long service life is required, i.e. the connections must remain tight over a long period of time (for example 50 years). Connection pieces that are also intended to be suitable for distributing hot and cold water within stories must withstand temperatures of up to at least 70° C. and pressures of up to at least 10 bar in the long term, during the stated time period.

Various connecting techniques are known for the mechanically fixed and fluid-tight connection of the tubular parts. In the case of a screw connection, the parts interacting with one another are provided with threads matching one another, in the case of a press connection mechanical pressing of one of the parts or of an additional pressing sleeve takes place. Plug-in connections make it possible for the tubular parts to be connected in a simple manner, by one of the parts being pushed onto or into the other, the mechanically fixed and fluid-tight connection being established substantially by the pushing-in or pushing-on movement, without screwing of the two parts onto one another or mechanical pressing being necessary.

Plug-in connectors consequently offer the advantage of simple and quick assembly. Previous plug-in connectors suitable for distributing hot and cold water within stories comprise a supporting nipple, onto which the line pipe is pushed. The supporting nipple supports the pipe and ensures dependable sealing.

DE 199 45 721 A1 (Friatec AG) shows, for example, a plug-in coupling with a basic body, a sealing ring, a clamping ring and an annular body that can be connected to the basic body. The end of a pipe to be connected by the plug-in coupling can be pushed into an axial annular gap between the basic body and the annular body. Arranged in this annular gap is the clamping ring, which lies with prestress against the clamping surface of the annular body and against the outer surface of the pushed-in end of the pipe.

DE 102 12 735 A1 (Georg Fischer Haustechnik AG) relates to a quick-action coupling for pipelines with fittings which has an inner part, an outer sleeve and an inner sleeve with a toothed ring and a clamping ring. The inner sleeve is made up of at least two parts, in order that the inner part can be inserted into it.

However, the supporting nipple of the known plug-in connectors that are suitable for distributing drinking water within stories on the one hand results in a constriction of the usable line cross section, and consequently leads to a drop in pressure in the line, and on the other hand connectors with supporting nipples impose very high requirements on the production tolerances to be maintained with respect to the pipes to be connected.

WO 02/16817 A1 (E. Hawle & Co. Armaturenwerke) concerns a connecting device without a supporting nipple for conduits for cables, data lines, etc. The conduits prevent ingress of dust, dirt or moisture. A middle part encloses the ends of the conduit and, together with the connecting sleeves, forms a recess which contains an enclosing lip seal. After being inserted into the middle part, the conduits are firmly held by a retaining element. However, the arrangement illustrated is not suitable for fluid-carrying systems of lines and is not designed for the corresponding loads; in particular, it must be expected that the sealing between the connecting device and the pipes would be lost if lateral forces were to act on the part of the pipe that is not held in the connection piece.

DE 20 2006 005 082 U1 (Ludwig Frischhut GmbH & Co. KG) discloses a tension-resistant plug-in connection without a supporting nipple for pipelines with a housing, which encloses a pipe, with a sealing element, which is arranged between the housing and the pipe, with a clamping wedge and with a clamp, which is given an additional holding function. The inserted pipe is held primarily by a resting surface at the end, which is located between the sealing element and a stop. At the front where the housing has an opening and between the sealing element and the clamping part, there is likewise in each case an edge, which contacts the pipe.

Also in the case of this device there is the risk that the sealing between the connecting device and the pipes will be lost if lateral forces act on the part of the pipe that is not held in the connection piece.

### SUMMARY OF THE INVENTION

It is an object of the invention to provide a connection piece that belongs to the technical field mentioned at the beginning, is suitable for distributing drinking water and avoids a drop in pressure.

The solution achieving the object is defined by the features of claim 1. According to the invention, the connection piece is formed without a supporting nipple in such a way that an inner lateral surface of the second tubular part is not contacted by the connection piece in the connected state.

The connection piece also has two peripheral guiding surfaces for the second tubular part, to be specific a first guiding surface in the region of an inner lateral surface of the first tubular part and a second guiding surface in the region of the inner lateral surface of the first tubular part that is arranged behind the first guiding surface with respect to an insertion opening of the connection piece. The peripheral recess for the annular sealing element is arranged between the first guiding surface and the second guiding surface. A first axial extent of the first guiding surface and a second axial extent of the second guiding surface respectively make up each at least one sixth of an inside diameter of the first tubular part, preferably at least one quarter of the inside diameter. It is also of advantage if the sum of the axial extent of the two guiding surfaces achieves at least two thirds, preferably at least three quarters, of the inside diameter of the tubular part.

On account of the structural design without a supporting nipple, the entire usable line cross section is maintained at the connecting point. The connection piece can also be constructed in a simple manner. The comparatively long guiding surfaces on both sides of the annular sealing element ensure that the second tubular part is held in the connection piece in a secure and fluid-tight manner, even if lateral forces act on the part of the pipe that is not held in the connection piece. The first guiding surface also ensures that the cross section of the pipe in the region of the seal is circular, even if the pipe is bent away or undergoes lateral forces directly outside the connection piece. The second, rear guiding surface prevents canting of the second tubular part in the region of the seal and ensures dependable sealing even in the case of beveled-away pipe ends. Furthermore, it is ensured by the long guiding surface behind the annular sealing element that, when pushing in the pipe, the fitter clearly feels when it has been pushed far enough into the connection piece; there is also a certain tolerance for the case in which the pipe is not pushed right up against the end of the plug-in connection.

The connection piece according to the invention is suitable in particular for use with solid plastic pipes. In the case of such pipes, the sealing on the outer side of the pipe presents no problem, in particular by contrast with composite pipes, in the case of which corrosion and delamination occur if medium comes into contact with the end face. The connection piece may be, in particular, part of a fitting which can create a connection between different elements of the system of lines (that is to say for example between two pipes or between a pipe and a valve-type fitting). The connection piece may also be part of a faucet with a shut-off, control and/or valve function. The faucets may be produced from metal, for example from silicon bronze, brass, red brass or high-grade steel, but also from plastic, for example from polypropylene (PP), polyvinyl chloride (PVC) or engineering plastics such as polysulfone (PSU), polyphenylsulfone (PPSU) or polyphthalamide (PPA). Metal surfaces may be improved or coated, for example chrome-plated, or provided with a film produced by a PVD process. Plastics may be fiber- or nanostructure-reinforced, in particular glass-fiber-reinforced.

A connection piece which is formed in such a way that, in the connected state, the second tubular part is partially enclosed by the first tubular part, wherein a peripheral recess in which an annular sealing element is received is made in said first tubular part thereof, on an inner lateral surface contacting the second tubular part in the connected state, and wherein the connection piece is formed in such a way that the second tubular part can be connected to the first tubular part in the sense of a plug-in connection by pushing it into the first part in a pushing-in direction, and which is formed without a supporting nipple in such a way that an inner lateral surface of the second tubular part is not contacted by the connection piece in the connected state, is preferably used in an arrangement for distributing hot and cold water within stories which is based on a fluid-carrying system of lines with pipes of PEx (crosslinked polyethylene) or polybutene (PB). These form the second tubular part, which can be connected to the first tubular part of the connection piece. Within the scope of the invention, PEx pipes of PEx-a, PEx-b and PEx-c can be used. PEx pipes and PB pipes do not corrode and delaminate even when they are provided with sealing on the outside. Moreover, they have a thermal stability and aging resistance that meet the requirements of distributing drinking water within stories. At the same time, they are also among those pipes that have adequate strength for a stable and durable connection without a supporting nipple with a connection piece according to the invention. The connection piece according to the invention is suitable in particular for the pipes used in distribution within stories with an outside diameter of 16 and 20 mm. However, its application area is not restricted to these diameters.

A connection piece according to the invention with long guiding surfaces can also be used, moreover, with pipes of polypropylene (PP), polyethylene (PE) and polyvinyl chloride (PVC).

A clamping and/or pinching element for axially securing the pushed-in second tubular part is advantageously arranged between the first guiding surface and the peripheral recess. A clamping element, a pinching element, a combined clamping and pinching element or a combination of a clamping element and a pinching element ensure reliable axial securement, and consequently dependable sealing. The element or the elements interact with a pushed-in second tubular part and secure it axially. The clamping function is obtained by a radial pressing force over a relatively large surface area on the second tubular part (that is to say primarily by force closure), the pinching function by claws of the pinching element penetrating into the second tubular part over a small area (that is to say primarily by form fitting). The claws of the pinching element are advantageously rounded. It has been found that this configuration has the effect that a rapid initial pinching action is achieved when the second tubular part is pulled back.

It is also conceivable in principle to arrange the clamping and/or pinching element in front of the first guiding surface or behind the peripheral recess for the annular sealing element. Alternatively, axial securement is created without a clamping and pinching ring, for example by the relative axial position between the connection piece and the pipe being fixed by a connection of the connection piece to the pipe outside the first tubular part.

The clamping and/or pinching element preferably comprises a clamping ring with a wedge-shaped cross section, which is received in a recess in the first tubular part that widens rearwardly with respect to the insertion opening, as well as a resilient pinching ring, which is arranged behind the clamping ring. The clamping ring comprises at least one clamping edge, which is pressed with a certain pressure peripherally onto the outer surface of the second tubular part, but may also have a number of clamping edges arranged one behind the other (for example in the form of a sawtooth profile).

The clamping ring advantageously has a number of axially running webs on its outer periphery. It has been found that, as a result, the receiving friction, and consequently the insertion force required for pushing the second tubular part in, can be reduced.

The clamping ring preferably has substantially axially running profilings on an outer lateral surface to interact with the recess. These profilings may be a plurality of webs, so that the clamping ring is given a form similar to that of a gear wheel. It has been found that, with the aid of these profilings, the friction between the clamping ring and the recess can be reduced, in particular when the second tubular part is pulled back. The depth of the profilings is chosen in particular such that, even with the pressing forces that occur during use, the outer surface of the clamping ring only contacts the receiving location with the profilings, and not with the regions lying in between.

Alternatively, the outer surface of the clamping ring is substantially smooth.

The clamping ring advantageously has on an end face contacting the pinching ring an inclined stop surface, which limits bending back of elements of the pinching ring during the pulling back of the pushed-in second tubular part. As mentioned above, the clamping ring penetrates into the second tubular part when the latter is pulled back, and consequently creates axial securement. It is ensured by the stop surface on the clamping ring that the claws of the pinching ring can only penetrate into the second tubular part to a predetermined depth. Further penetration is prevented by the lying of the angled claws against the inclined stop surface. The stop surface consequently also limits the penetration depth of the elements of the pinching ring. This prevents damage to the second tubular part that could occur in an extreme case to the extent that the pipe is wrenched off. The angle between the outer surface of the second tubular part and the stop surface is advantageously between 95 and 150°, preferably between 105 and 135°.

The clamping ring is displaceable in the widening recess. This ensures that, irrespective of tolerances of the pipe diameter, the clamping/pinching ring becomes wedged in the recess when the second tubular part is pulled back and in this way axially secures the second tubular part. Optimum securement and at the same time easy pushing-in of the second tubular part is obtained if the rearwardly widening recess has an angle of 1-30°, preferably 3-20°, particularly preferably 5-15°, in relation to an axis of the first tubular part. The clamping ring is advantageously produced from plastic, for example from glass-fiber-reinforced polyamide, PPSU or some other suitable material.

In order that the outside and inside diameters are variable, the clamping ring is slit or comprises a number of clamping segments which are connected to one another by deformable connecting portions. The clamping ring is advantageously formed such that it has a prestress and is widened when the pipe is pushed in. This ensures reliable axial securement of the pipe.

The clamping ring comprises a first resting surface for contacting a lateral surface of the rearwardly widening recess as well as a second resting surface for contacting an outer side of the second tubular part. The first resting surface of the clamping ring thus advantageously has at least one portion in which the angle of the first resting surface to the second resting surface of the clamping ring is different from the angle of the rearwardly widening recess to the axis of the first tubular part. The difference between the angles is in this case preferably 0.1-10°, particularly preferably 0.1-5°, in particular 0.5-2°. The first resting surface may be formed as a cone and have a constant angle to the second resting surface over the entire extent; it may also comprise a number of portions with different angles, for example a first portion, in which the angle is greater than that between the rearwardly widening recess and the axis of the first tubular part, and a second portion, in which the angle is smaller. If a number of portions are present, they are advantageously arranged such that the form of the first resting surface is substantially convex. Finally, the outer surface may also be convexly curved or have both planar and curved portions.

One effect of the difference in angle is to make easy pushing-in of the pipe possible, with a low force of resistance of the clamping ring. In this case, the first-mentioned angle may be smaller than the second-mentioned angle, or it is greater than the second-mentioned angle. Depending on the formation, when the pipe is pushed back, the rear end or the front end of the second resting surface, or in the presence of a toothing or profiling the rearmost tooth or the rearmost profile or the forwardmost tooth or the forwardmost profile of the second resting surface, comes directly into engagement with the outer surface of the second tubular part, whereby a high clamping force is built up very quickly.

If a number of portions with different angles are present, it is advantageous if the transition between a first portion and a second portion is formed radially outside a profile or tooth, in particular radially outside the tooth nearest the mouth, so that the respective tooth or the respective profile directly exerts a great clamping force locally on the second tubular part.

In the case of an advantageous embodiment of the invention, the pinching ring has an outer circular-ring-shaped radial portion and an inwardly adjoining slit inner portion, wherein the inner portion includes an angle of 0-70°, preferably 1-60°, particularly preferably 20-50°, with the outer portion. When there is an adequately large angle between the two portions, the pinching ring can be guided at its corresponding kink-like transition on the adjacent portion of the connection piece, and consequently be centered with respect to the second tubular part that is to be pushed in. If the angle is smaller with respect to the regions of the inner portion that interact with the outer side of the second tubular part, a few (preferably at least 3) tooth-like parts of the inner portion may be configured with a greater angle and the guidance on the adjacent portion of the connection piece ensured in this way. Alternatively, the guidance takes place in the region of the outer portion, for example by providing outwardly adjoining the outer portion a further, cylindrical portion, which is guided on an axial portion of the connection piece.

The specified angles also ensure a dependable pinching action even when there is a small axial displacement. The pinching ring is preferably formed and arranged in such a way that a penetration depth of 0.1-1.0 mm, particularly preferably 0.2-0.5 mm, is achieved. The pinching ring is preferably produced from spring steel, but may also be formed from some other material (for example copper). The material thickness is advantageously 0.1-1.0 mm, preferably 0.2-0.6 mm, particularly preferably 0.25-0.4 mm. The forming of the pinching ring from metal ensures that it durably retains its elasticity and still ensures axial securement even at the end of the long service life that is required.

Alternatively, the clamping ring may also be formed in some other way. As mentioned above, embodiments which have only a clamping element or only a pinching element or dispense entirely with clamping and pinching elements are also possible.

In a preferred embodiment, in the region of the first guiding surface and/or a further guiding surface, arranged ahead of the annual sealing element, for the second tubular part there is formed a bead-like projection for working an outer surface of the second tubular part when the latter is pushed in.

The bead-like projection may be an integrated deburrer with a sharply tapered profile or else an integrated roller-burnishing tool with a rounded cross section. The projection is formed in an annularly peripheral manner. The maximum height of the projection is advantageously at most 0.30 mm and preferably lies between 0.01 and 0.10 mm. The projection may be formed from material of the cap or of the basic body, but also as a cast-in or molded-in insert (for example of metal). In order that working of the outer surface of the second tubular part is made possible, the bead is formed from a material which is harder than the material of the outer surface of the second tubular part. There may also be a number of beads formed on one or more guiding surfaces, for example a deburring tool at the entry of the connection piece and a roller-burnishing tool at the opposite end of the first guiding surface. The further guiding surface mentioned is arranged in particular between the first and second guiding surfaces, for example between a receiving location for a clamping and/or pinching ring and the receiving location for the annular sealing element.

With the aid of the deburring or roller-burnishing tool, pipe damage such as scratches or scores are made good, thereby ensuring dependable sealing between the outer surface of the second tubular part and the annular sealing element even in the case of an initially damaged outer surface.

The annular sealing element is preferably a shaped packing in the form of a lip seal. Subsumed here under the term lip seal are also seals that are sometimes referred to as a “compact seal” and have not only lip-like parts but also a compact basic body in which the lips are formed in the manner of extensions. Such an element makes dependable sealing possible, further assisted by the medium pressure of the fluid carried in the second tubular part and in the connection piece. By the use of suitably formed shaped packing, the required insertion force for the second tubular part can also be reduced to practicable values of below 100 N, preferably below 40 N, and compensate for greater tolerances of the outside diameter of the pipe.

In this respect it is advantageous if the recess for the annular sealing element widens rearwardly with respect to the insertion opening and if the lip seal has a substantially V-shaped cross section and is received with its open end face in the pushing-in direction in the recess. The open end face between the two legs of the V shape is therefore facing the medium carried, the converging side of the entry opening of the connection piece. On account of its pressure, the medium presses the two legs apart and in this way assists dependable sealing. The wedge shape of the lip seal makes it possible for the second tubular part to be easily pushed in and is adapted to the widening recess for the annular sealing element.

The outer leg, which interacts with the lateral surface of the recess, advantageously has a profiling, for example in the form of a number of peripheral grooves. It has been found that such a profiling further improves the sealing dependability of such a lip seal.

Alternatively, the annular sealing element may also be configured, for example, as an O-ring.

The annular seal is advantageously produced from a rubber material (for example EPDM, HNBR) and has a hardness of, for example, 30-95 Shore A, preferably 60-80 Shore A. It has been found that, with a material in this hardness range, best possible sealing with greatest possible pipe tolerances can be achieved. In order to increase the sliding capability of the annular seal if required, it may be Teflon-coated, greased and/or oiled. In this way, the insertion force can be reduced. A grease coating on the inner side of the annular seal may also create improved sealing with respect to unevennesses of the outer side of the pipe, by the applied grease penetrating into these unevennesses (such as longitudinal scores or scratches). In order to prevent washing out of the grease, it is advantageously introduced into a recess on the inner side of the annular seal that is axially and radially enclosed. Suitable greases are, for example, based on the combination of an organic polymer and dimethyl polysiloxanes or on silicone oil, and preferably belong to NLGI classes 1-3.

The annular seal may also be produced from a water-swellable material, so that it swells and intensifies the sealing effect when it first comes into contact with the water carried in the line.

The annular sealing element advantageously comprises a first annular sealing part and a second annular sealing part, wherein the first annular sealing part is produced from a material which has a greater hardness than the material from which the second annular sealing part is produced. As stated above, the hardness of the first annular sealing part is, for example, 30-95 Shore A, preferably 60-80 Shore A, while the second annular sealing part has a lower hardness in the range of 20-80 Shore A, preferably 40-70 Shore A. The harder part of the annual sealing element ensures the required mechanical stability and prevents extrusion along the gap between the connection piece and the outer side of the pipe. The softer part adapts itself as well as possible to the surface of the pipe and so creates dependable sealing even in cases of pipe unevennesses, such as for example longitudinal scores or scratches.

The two annular sealing parts may be mechanically fastened to one another, for example by form fitting of one in the other, by adhesive bonding or by being produced in a two-component injection-molding process. They may, however, also be separately formed and, if appropriate, introduced individually into the connection piece.

The first and second annular sealing parts are preferably formed in such a way that the first pipe sealing part supports the second pipe sealing part axially on both sides. Thus, extrusion of the softer pipe sealing part along the outer side of the pipe is prevented and the mechanical stability of the annular sealing element is ensured. The first pipe sealing part may, for example, be formed in a substantially U-shaped manner, so that the second pipe sealing part can be received between the two legs of the first pipe sealing part and the outer side of the pipe.

The above features of preferred configurations of the annular sealing element, in particular also the grease coating on the inner side of the seal and/or the two-part construction of the element, can also be advantageously realized as part of connection pieces that are not of the type according to the invention. In particular, their use is also advantageous in the case of connection pieces without a supporting nipple, which do not have the guiding surfaces according to the invention or the guiding surfaces of which do not have the extents specified.

The connection piece preferably comprises a cap part, which partially encloses the second tubular part in the connected state. The cap part may assume various tasks: for instance, it may protect the connecting point from external influences, serve as a support or receiving location for a clamping and/or pinching ring, receive an annular seal, form a means of preventing twisting, etc.

The cap part is advantageously releasably fastened to a basic body of the connection piece, in order for example to make release of the connection possible. It is not absolutely necessary for the release to take place non-destructively. A cap part which can be subsequently attached also makes easier assembly of the connection piece possible. For instance, a widening recess for the clamping element may, for example, be arranged at the transition between the cap part and the basic body, whereby the clamping element can be easily introduced into this recess before the cap part and the basic body are assembled.

The cap part is preferably fastened to the basic body by a screw connection. Such a connection can be easily established and released again and offers great dependability. The screw cap advantageously comprises external flats, so that tools for tightening and loosening the cap can be used. The flats preferably have a special contour, so that special tools have to be used and unauthorized manipulations are prevented. Alternatively, however, the flats may also have conventional contours, so that conventional tools, such as for example fork wrenches, can be used.

Alternatively, the cap part may, for example, be fastened to the basic body by means of a clip connection or a bayonet connection.

The basic body may be produced from metal (for example high-grade steel, red brass, silicon bronze, brass, copper, steel, etc.) or plastic (for example PSU, PPSU, PPA, PA, etc.), wherein the plastics materials may be fiber- or nanostructure-reinforced, in particular glass-fiber-reinforced. A basic body of metal is very durable, ensures great stability and can also be repeatedly used. Particularly preferably, the basic body is produced from a flow-optimized sand casting. The minimal pressure loss of the connection piece without a supporting nipple can in this way be complemented by a minimal pressure loss of the remaining parts of the fitting or the faucet, in particular in the case of bends or T pieces. Moreover, a thread for fastening a cap part can be easily cut into the outer surface of a metal basic body, a metal basic body is well-suited for press connections and may form part of a faucet. Plastics that can be used for basic bodies are advantageously UV-stable and stabilized against hydrolysis.

The cap part is advantageously produced from plastic, for example from PPSU, PSU, PPA or some other suitable plastics material, for example glass-fiber-reinforced polyamide. Plastic as the material for the cap makes it possible to form a tamperproof element and can be easily inscribed. A simple clip connection with the basic body is also possible. Plastic caps may, moreover, be made such that they are entirely or partially transparent. Thus, the securing elements, for example a pinching ring and/or a clamping ring, are visible from the outside. If the basic body is also made from a transparent material, the penetration depth of the second tubular part can also be directly perceived from the outside. In particular in the case of a destructive releasing operation, the cap part is in each case replaced.

In the case of a suitable form of the cap part, it does not come into contact with the drinking water carried in the system of lines. Consequently, plastics such as polyamide are also suitable for the production of the cap part.

The first guiding surface is preferably formed in the region of an inner lateral surface of the cap part, the second guiding surface correspondingly preferably on the basic body.

The peripheral recess for the annular sealing element is preferably formed in the basic body, i.e. the recess is delimited both at the front and rear and on the outside by the basic body. Encapsulation ensures dependable guidance of the annular sealing element, and consequently high compressive strength. The separate encapsulation of the annular sealing element separates the sealing function from the pinching and clamping function. The sealing dependability can be additionally increased by a distance being provided between the location of the sealing and the location of the pinching/clamping.

Alternatively, the recess for the annular sealing element is formed between the cap and the basic body or the basic body and a further element or between the cap and a further element.

A preferred construction of the connection piece is therefore as follows: screwed onto the basic body is a cap part, on the lateral surface of which the first guiding surface is formed. The first guiding surface is adjoined at the rear, in the inner lateral surface of the cap part, by the widening recess for the clamping element. The following portion of the first tubular part is formed by the basic body. In this portion, first the peripheral recess for the annular sealing element and, behind it, the second guiding surface are formed. The annular sealing element is completely received in the basic body; the clamping element and the pinching element are held between the cap part and the basic body. The clamping element advantageously has a prestress, which ensures that, in the initial state, i.e. before the second tubular part is pushed in, the clamping element, the pinching element and the adjoining portion of the basic body directly follow one another. The flexible annular sealing element can be easily introduced into the recess in the basic body, while the clamping element and the pinching element are placed at the intended points before the assembly of the cap part and the basic body.

Advantageously arranged between the cap part and the basic body is a tamperproof element, which permanently indicates when release of the cap part from the basic body has taken place. The tamperproof element particularly comprises a predetermined breaking point, which is damaged when the cap part is released. The removed (and destroyed or damaged) cap part can be replaced by a new cap part if a new connection is to be created.

In a preferred embodiment, the tamperproof element is configured as follows: an external thread is formed on an outer lateral surface of the basic body and an internal thread is formed on an inner lateral surface of the cap part, wherein the cap part can be screwed with its internal thread onto the external thread of the basic body. Also formed on the outer lateral surface of the basic body is an undercut region, in which a tab-like portion of the cap part can engage when the latter is screwed on. The undercut region and the tab-like portion are thus formed in such a way that the tab-like portion breaks when the screwed-on cap part is released from the basic body.

Other tamperproof elements are also conceivable, for example in the manner of a tamperproof ring which is connected to a main part of the cap part by way of bridges formed as predetermined breaking points.

The connection piece advantageously has a marking, which indicates a predetermined insertion depth of the second tubular part, for example a groove, an elevation or a colored indication. On the basis of the marking, the fitter can mark the required insertion depth on the second tubular part before pushing-in and easily establish after pushing-in whether the second tubular part has been inserted far enough into the connection piece. Alternatively, the marking may be performed on the second tubular part, for example with the aid of a gage or a correspondingly formed parting-off tool.

Further advantageous embodiments and combinations of features of the invention emerge from the following detailed description and the patent claims as a whole.

### BRIEF DESCRIPTION OF THE DRAWINGS

The drawings used for explaining the exemplary embodiment show:

FIGS. 1A, B a cross section of an embodiment of a connection piece according to the invention before and after the pushing-in of an end of a pipe;

FIG. 2 an oblique view of a cut-open portion of the basic body and the screw cap to illustrate the tamperproof connection;

FIG. 3 a cross section of a lip seal for the connection piece according to the invention;

FIG. 4 a cross section of a multipart sealing element for the connection piece according to the invention;

FIG. 5 an oblique view of a clamping ring for a connection piece according to the invention;

FIG. 6 a cross section through the clamping ring;

FIG. 7 an oblique view of a pinching ring for a connection piece according to the invention; and

FIGS. 8A, B a cross section through different embodiments of screw caps for a connection piece according to the invention.

In principle, the same parts are provided with the same designations in the figures.

### WAYS OF CARRYING OUT THE INVENTION

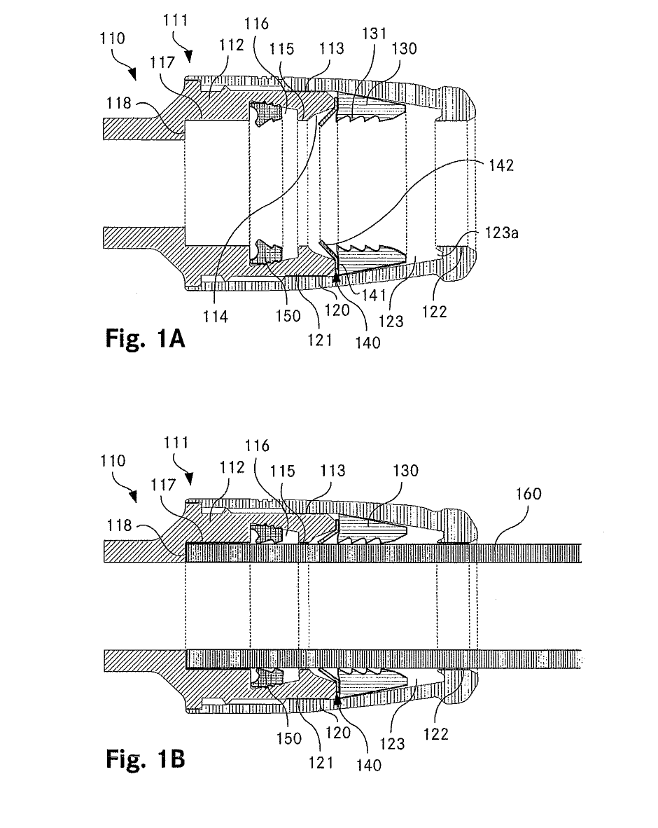

FIGS. 1A and 1B show a cross section of an embodiment of a connection piece according to the invention before and after the pushing-in of an end of a pipe. Illustrated is a component 110 (for example a fitting, valve-type fitting, etc.) with a connection piece 111, which is suitable for receiving an end of a pipe 160 of PEx (crosslinked polyethylene). The connection piece 111 comprises a basic body 112, which is produced in one piece with the component 110 from red brass, and a sleeve-like screw cap 120, partially enclosing said body, of glass-fiber-reinforced and UV-stabilized polyamide (PA). The screw cap 120 is screwed onto a corresponding external thread 113 of the basic body 112 by way of an internal thread 121.

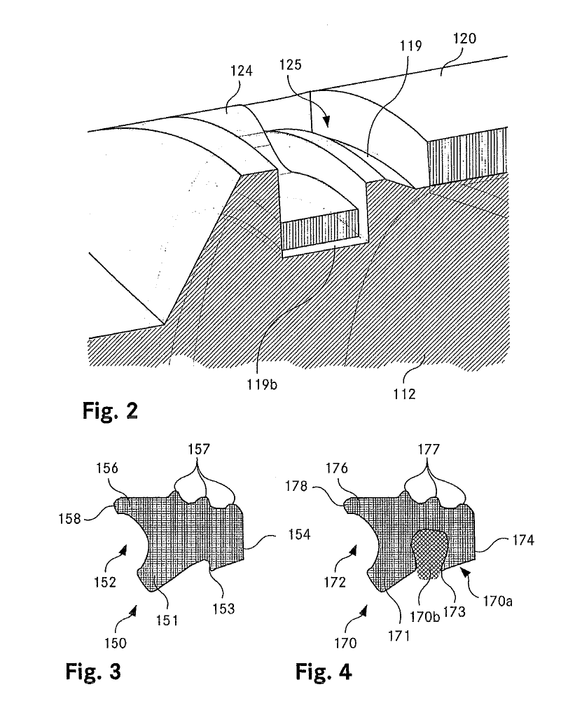

Between the screw cap 120 and the basic body 112 there is a tamperproof connection, which ensures that the screw cap 120 is visibly damaged when it is removed again from the basic body 112. The tamperproof connection is described in more detail further below, in conjunction with FIG. 2.

The screw cap 120 is formed such that it tapers at its front part, toward its free end, and has in a front portion an inside cross section which corresponds to the outside cross section of the pipe 160 to be received. The screw cap consequently forms in this portion a cylindrical guiding surface 122 for the pipe 160. The wall of the screw cap 120 is beveled in the region of the mouth, so that the pipe 160 is automatically centered when it is pushed in.

The screw cap 120 also has in its front part, near its free end, an annular recess 123 with an approximately trapezoidal cross section, which widens in the pushing-in direction. Held in this recess 123 is a clamping ring 130 of glass-fiber-reinforced polyamide (glass fiber content 30%. The outer contour of said ring corresponds substantially to the inner cross section of an axial region of the recess 123. The clamping ring 130 has a continuous axial slit, so that it has a certain variability in diameter. The inner surfaces of the clamping segments are formed in such a way that they can contact the outer lateral surface of the pipe 160 over a large surface area, in order to produce a clamping action between the screw cap 120 and the pipe 160. At its front region, adjoining the guiding surface 122, the recess 123 runs out in an undercut portion 123a. At its front end, the clamping ring 130 is correspondingly formed such that it tapers, so that the forwardmost region of the clamping ring 130 can be received in the undercut portion 123a. This allows a lengthening of the displacement path for the clamping ring 130 in the direction of the mouth of the screw cap 120, without the guiding surface 122 having to be shortened. The delimitation of the undercut portion 123a also forms a stop for the clamping ring 130, which prevents further displacement and also ensures that there is still a clamping force even in the possible case of a reduction in the cross section of the clamping ring 130 caused by aging.

The outer lateral surface of the clamping ring 130 defines a first resting surface for contacting a lateral surface of the rearwardly widening recess 123.

The inner lateral surface of the clamping ring 130 for contacting the outer lateral surface of the pipe 160 has a profiling 131 with four clamping edges running around peripherally in planes perpendicular to the axis of the pipe. The ridges of the clamping edges therefore define a second resting surface for contacting the outer side of the pushed-in pipe 160. The angle between the first resting surface and the second resting surface is 11°. The angle between the lateral surface of the rearwardly widening recess 123 and the axis of the pipe 160 is 9°, that is to say it is somewhat smaller.

Arranged such that it rearwardly adjoins the clamping ring 130 is a pinching ring 140 of spring steel with a thickness of 0.35 mm. This pinching ring has an outer annular portion 141 and, adjoining this portion 141, a slit inner portion 142. The slit inner portion 142 has a plurality of spaced apart teeth, which are all bent away from the outer portion 141 at an angle of 45°, and consequently point obliquely rearward (i.e. away from the mouth of the connection piece 111). The pinching ring 140 is guided in the region of the bending kink on a correspondingly formed portion of the basic body 112 and, as a result, is centered with respect to the pipe 160 that is to be pushed in. The basic body 112 forms behind the pinching ring 140 a peripheral, rearwardly narrowing recess 114, in which the inner portion 142 of the pinching ring 140 is received and which offers space for further deformation of the inner portion 142 of the pinching ring 140. This recess 114 is adjoined by a further cylindrical guiding surface 115, the inside diameter of which corresponds to the outside diameter of the pipe 160 to be received.

Formed in turn behind the guiding surface 115 in the basic body 112 is a further peripheral recess 116 with an approximately trapezoidal cross section, which widens in the pushing-in direction. Held in this recess 116 is a lip seal 150 of elastic material with an approximately V-shaped cross section. The lip seal 150 is described in more detail further below, in conjunction with FIG. 3.

Adjoining the recess 116 for the lip seal 150 in the basic body 112 is a further cylindrical portion with a guiding surface 117. Formed at the rear end of this guiding surface 117 in the basic body 112 is a stop 118, formed as a step, for the end face of the pipe 160. Following this step, the inside cross section of the basic body 112 corresponds to the inside cross section of the pipe 160. Consequently, a fluid channel with a constant cross section is formed by the pushed-in pipe 160 and the basic body 112.

The plug-in connector is assembled by first inserting the lip seal 150 into the corresponding recess 116 in the basic body 112. On account of the elasticity of the lip seal 150, this is accomplished without any problem. Subsequently, the clamping ring 130 and the pinching ring 140 are introduced into the screw cap 120 from the rear. With its internal thread 121, the screw cap 120 can then be screwed along with the clamping ring 130 and the pinching ring 140 onto the external thread 113 of the basic body 112, the tamperproof connection between the screw cap 120 and the basic body 112 also being created by the snapping-in of a tab-like portion (see below).

To create a plug-in connection, the pipe 160 is introduced into the mouth of the plug-in connector. This operation is assisted by the beveling formed in the region of the mouth of the screw cap 120. Next, the pipe 160 comes into contact with the clamping edges (profiling 131) of the clamping ring 130. Further beveling in the region of the mouth-side end of the clamping ring 130 brings about a centering of the clamping ring 130 with respect to the pipe 160 and the recess 123 in the cap part 120. If required, the clamping ring 130 received in the recess 123 is taken along (and at the same time widened) until the pipe 160 can fit in it. Subsequently, the pipe 160 contacts the free ends of the inner portions 142 of the pinching ring 140. Because they are pointing obliquely in the pushing-in direction, when pushing-in continues they are elastically deformed and scarcely prevent the pushing-in. However, pulling-back of the pipe 160 pinched by the claws is then only possible by exerting extreme force, and generally leads to the pipe 160 being damaged, by rupturing or bursting as a result of the pressure of the medium.

As the pipe 160 continues to be pushed on, the lip seal 150 is slightly deformed and pressed against the lateral surface of the corresponding recess 116. The pushing-in of the pipe 160 is completed when the free end face of the pipe 160 is lying against the stop 117 of the basic body 112. In the corresponding position, the pipe 160 is securely supported by the guiding surface 122 at the front end of the screw cap 120, the guiding surface 115 in the region of the front end of the basic body 112 and the guiding surface 118 in the rearmost region of the receiving location for the pipe 160.

The sealing of the pipe 160 with respect to the connection piece 111 takes place on the outer side of the pipe, by the lip seal 150. The axial securement of the pushed-in pipe takes place by the pinching ring 140 and the clamping ring 130. If it is attempted to pull the pipe back, the pinching ring 140 penetrates into the outer lateral surface of the pipe, and consequently creates a form-fitting connection. The pulling-back movement of the pipe 160 is consequently transferred to the clamping ring 130 by way of the pinching ring 140. On account of the different angles between the resting surface for contacting the lateral surface of the recess 123 or the lateral surface of the rearwardly widening recess 123 and the axis of the pipe 160, the rearmost clamping edge of the profiling 131 can immediately come into engagement with the outer side of the pipe and directly exert a high pressing pressure on it. Should further pulling-back of the pipe 160 still be possible, the clamping ring 130 comes into contact with its entire outer lateral surface with the lateral surface of the recess 123 and acts with all four clamping edges on the outer surface of the pipe. On account of the conicity of the recess 123, the clamping ring 130 becomes wedged in it, and consequently reliably prevents further pulling-back. The geometry of the clamping ring 130, of the corresponding recess 123 and of the pinching ring 140 is chosen such that, even with the maximum displacement of the clamping ring 130 limited by the undercut portion 123a, the pinching ring 140 does not touch the screw cap 120, and consequently cannot cause the latter to be damaged.

The connection piece 111 can be repeatedly used, it being possible for the screw cap 120 to be unscrewed to remove the pipe 160 that is held by said connection piece, as a result of which the tamperproof connection is destroyed. To establish a new connection, the screw cap 120, and with it the clamping ring 130 and the pinching ring 140, can be replaced by new parts. If appropriate, the lip seal 150 can also be replaced.

The plug-in connector shown in FIG. 1 is designed for pipes with an outside diameter of 16 mm. The insertion depth for the pipe 160 is 36 mm, the axial extent of the rear guiding surface 117 is 8 mm, that of the front guiding surface 122 is 4 mm. The middle guiding surface 115 increases the overall guidance by a further 1.2 mm. The maximum displacement part of the pinching ring 140 is 4.4 mm (which corresponds to a difference in diameter of the pipe of 1.55 mm), that of the clamping ring 130 is 4.5 mm. In the case of the exemplary embodiment illustrated, the insertion depth corresponds precisely to the length of the screw cap 120. Consequently, before pushing-in, the user can use the screw cap 120 to apply a marking to the pipe 160 and, once pushing-in has taken place, establish whether the pipe 160 has been pushed in fully.

FIG. 2 shows an oblique view of a cut-open portion of the basic body and the screw cap to illustrate the tamperproof connection. The screw cap 120 comprises in its lateral surface, in the region of the free end, a tab-like portion 124, which is bent inward in the form of an arc, and a continuous recess 125 rearwardly adjoining said portion. On account of the material elasticity of the screw cap 120, the tab-like portion 124 has a certain elastic deformability. When the screw cap 120 is screwed onto the basic body 112, the tab-like portion 124 is gradually pushed over a conical portion 119a in the outer lateral surface of the basic body 112 until it engages in a recess 119b in the basic body 112 of a rectangular cross section. A conical portion 119a of the basic body 112 is received in the continuous recess 125 of the screw cap 120.

The screw cap 120 can, in principle, be released again from the basic body 112 by unscrewing. Because the recess 119b of the basic body is restricted in the releasing direction by a steep wall, the tab-like portion 124 cannot however join in with the movement of the screw cap 120, which has the result that it is detached from the main part of the screw cap 120. The detachment of the tab-like portion 124 is a clearly visible sign that the screw cap 120 has already been screwed onto the basic body 112 once before, and therefore assumes a tamper-indicating function.

FIG. 3 shows a cross section of a lip seal for the connection piece according to the invention. The lip seal 150 consists of EPDM with a Shore hardness of 70. It is substantially V-shaped in cross section, with an inner lip 151, which forms a first leg of the V shape, and an outer lip 156, which forms the second leg of the V shape. Formed between the two lips 151, 156 is an open end face in the form of the peripheral indentation 152. Formed as an extension of the outer lip 156 are three grooves 157; the extension of the inner lip 151 has a step 153. The end of the outer lip adjoining the open end face of the lip seal 150 has eight substantially hemispherical nubs 158, uniformly distributed on the periphery. The rear end face 154, opposite from the opening face, is planar. The inner lip 151 has an angle of on average about 110° in relation to the rear end face 154; the outer lip 156 has an angle of on average about 95° in relation to the rear end face 154. The open end face is inwardly inclined with respect to the rear end face 154 by about 20°. The wedge shape of the lip seal 150 produced by the angles specified makes it possible for the pipe 160 to be easily pushed in and is adapted to the widening recess for the annular sealing element.

The inclination of the outer lip 156 and of the outer portion adjoining it is adapted to the inclination of the recess 116 receiving the lip seal 150 such that the rear end face runs radially with respect to the receiving space for the pipe 160 when the lip seal 150 is inserted in the basic body 112. The grooves 157 in the extension of the outer lip 156 ensure dependable sealing between the outer surface of the seal and the recess 116 in the basic body. The open end face between the two lips 151, 156 faces the medium that is carried. Therefore, on account of its pressure, the medium presses the two lips 151, 156 apart, and consequently assists dependable sealing both with respect to the recess 116 and with respect to the outer surface of the pipe 160.

In the intermediate space in front of the step 153 that is formed by the front lip 151, a certain amount of grease can optionally be introduced, for example a grease which is based on the combination of an organic polymer and dimethyl polysiloxane and belongs to one of NLGI classes 1-3. On account of its fluidity, the grease penetrates into unevennesses of a small surface area on the outer side of the pipe, and in this way creates an additional sealing effect. Being received in the intermediate space prevents the grease from being washed out.

FIG. 4 shows a cross section of a multipart sealing element 170 for the connection piece according to the invention. This can be used instead of the sealing element 170 illustrated in conjunction with FIG. 3 without any further adaptations being made in the connection piece according to FIGS. 1-3.

The sealing element 170 is made up of a first sealing part 170a and a second sealing part 170b. The first sealing part 170a consists of EPDM with a Shore hardness of 70. It is substantially V-shaped in cross section, with an inner lip 171, which forms a first leg of the V shape, and an outer lip 176, which forms the second leg of the V shape. Formed between the two lips 171, 176 is an open end face in the form of the peripheral indentation 172. Formed as an extension of the outer lip 176 are three grooves 177; the extension of the inner lip 171 has a step 173. The end of the outer lip adjoining the open end face of the sealing part 170a has eight substantially hemispherical nubs 178, uniformly distributed on the periphery. The rear end face 174, opposite from the opening face, is planar. The inner lip 171 has an angle of on average about 110° in relation to the rear end face 174; the outer lip 176 has an angle of on average about 95° in relation to the rear end face 174. The open end face is inwardly inclined with respect to the rear end face 174 by about 20°. The wedge shape of the sealing element 170a produced by the angles specified makes it possible for the pipe 160 to be easily pushed in and is adapted to the widening recess for the annular sealing element.

Formed in the inner surface of the first sealing part 170a, adjacent the step 173, is a recess with a slight undercut, in which the second sealing part 170b is received in a fitting manner. This second sealing part has a substantially oval cross section, which slightly tapers inwardly, toward the outer surface of the pipe, and is flattened on the inner side. The second sealing part 170b is produced from EPDM with a Shore hardness of 50, that is to say is softer than the first sealing part 170a. It can consequently adapt itself to unevennesses of the outer surface of the pipe and ensure reliable sealing. At the same time, it is mechanically supported both axially and radially outward by the first sealing part 170a. The function of the sealing element 170 otherwise corresponds to that of the lip seal 150 described at the beginning in conjunction with FIG. 3.

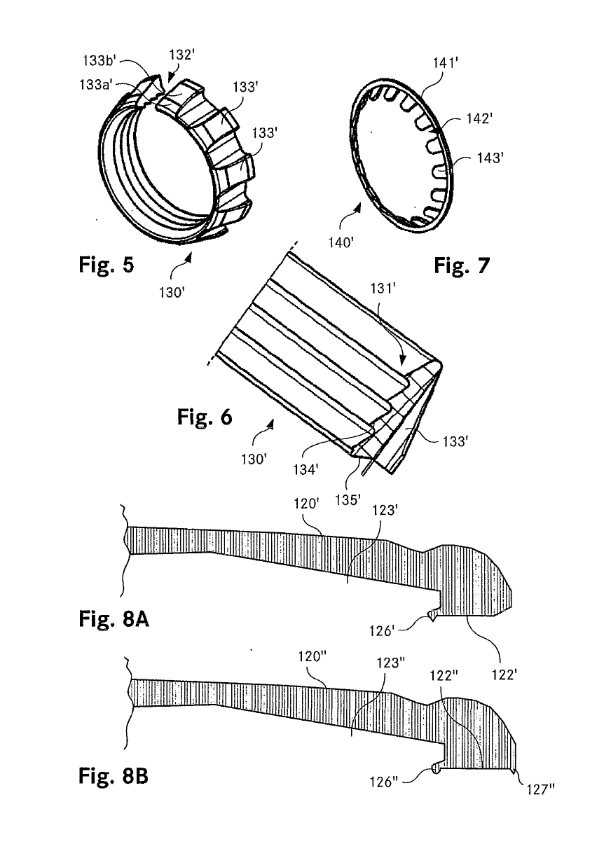

FIG. 5 shows an oblique view of a clamping ring 130′ for a connection piece according to the invention; FIG. 6 shows a radial cross section through this clamping ring. The clamping ring 130′ performs the same functions as the clamping ring 130 described in conjunction with FIGS. 1A and 1B. It is in turn produced from glass-fiber-reinforced polyamide (glass fiber content 30%). The clamping ring 130′ has a continuous axial slit 132′, so that it has a certain variability in diameter. The outer lateral surface of the clamping ring 130′ defines a first resting surface for contacting the lateral surface of the rearwardly widening recess. It has a plurality of webs 133′, which form the resting surface. The inner lateral surface of the clamping ring 130′ for contacting the outer lateral surface of the pipe has in turn a profiling 131′ with four clamping edges 134′ running around peripherally in planes perpendicular to the axis of the pipe. The webs have two differently inclined portions 133a′, 133b′, wherein an angle between the front portion 133a′ (that is to say that portion in the region of smaller cross section of the clamping ring 130′) and the inner resting surface for the pipe is 32° and an angle between the rear portion 133b′ (that is to say that portion in the region of greater cross section of the clamping ring 130′) and the inner resting surface for the pipe is 27°. The different angles have the effect of intensifying the pressing pressure of the clamping ring 130′ when the pushed-in pipe is pulled back.

Formed on the rear end face adjacent the profiled inner lateral surface is an inclined stop surface 135′. It includes an angle of 120° with the inner resting surface for the pipe.

FIG. 7 shows an oblique view of a pinching ring 140′ for a connection piece according to the invention. The pinching ring 140′ is produced from spring steel with a thickness of 0.35 mm. It has an outer annular portion 141′ and, adjoining this portion 141′, an inner portion 142′, which is formed by a plurality of teeth 143′. In the unloaded state illustrated, all these teeth are bent away from the outer portion 141′ approximately at an angle of 45°, and in the fitted state consequently point obliquely rearward, i.e. away from the mouth of the connection piece 111. The teeth 143 are rounded at their free end. This shaping has the effect that a rapid initial pinching action is achieved when a pipe pushed into the connection piece is pulled back.

FIGS. 8A and B show cross sections through different embodiments of screw caps for a connection piece according to the invention. Only the free end with the first guiding surface 122′ or 122″ is respectively illustrated. Otherwise, the caps are formed in the same way as that described in conjunction with FIGS. 1 and 2.

The screw cap 120′ illustrated in FIG. 8A has at the rear (i.e. inner) end of the guiding surface 122′ an inner bead 126′, which has in cross section approximately the shape of a triangle, and consequently forms an inwardly directed working edge. The height of the edge above the guiding surface 122′ is about 0.10 mm. When the pipe is pushed into the connection piece, this working edge acts as a deburring tool, removes burr that is present on the outer surface of the pipe and creates a uniform and smooth outer surface for the interaction with the annular sealing element.

The screw cap 120″ illustrated in FIG. 8B has at the front (i.e. outer) end of the guiding surface 122″ an inner bead 127″, which has in cross section approximately the shape of a triangle, and consequently forms an inwardly directed working edge. The height of the working edge above the guiding surface 122″ is about 0.10 mm. When the pipe is pushed into the connection piece, the working edge acts as a deburring tool, and consequently removes burr that is present on the outer surface of the pipe. At the rear (i.e. inner) end of the guiding surface 122″, the screw cap 120″ has an inner bead 126″, which is formed in cross section such that it is approximately half-round, and consequently has an inwardly directed curvature. The maximum height of the curvature is about 0.10 mm. When the pipe is pushed into the connection piece, this curvature acts as a roller-burnishing tool to create a uniform outer surface for the interaction with the annular sealing element.

Both in the embodiment according to FIG. 8A and in that according to FIG. 8B, the bead(s) is or are formed in one piece with the screw cap, i.e. from glass-fiber-reinforced and UV-stabilized polyamide (PA). Since this material is much harder than that of the pipe to be pushed in (PEx or polybutene) and generally only one working operation takes place, the hardness of said material is adequate for the deburring or roller-burnishing. However, it is also conceivable in other embodiments to produce a deburring or roller-burnishing tool from some other material (for example from a metal) and fasten it to the screw cap, in particular embed it. Corresponding beads may, moreover, also be formed further inward, in particular on a guiding surface between the receiving location for the clamping ring and pinching ring and the receiving location for the annular sealing element. However, this arrangement entails a somewhat higher pipe inserting force.

The invention is not restricted to the exemplary embodiments described above. It can be differently configured in many respects. For example, the pinching ring may be guided in some other way, for example it may have outwardly adjoining the outer annular portion a cylindrical portion which is guided in a corresponding axially running recess in the basic body. This variant is of advantage in particular whenever the inner portion is only bent away from the outer portion at a small angle. As an alternative to the cylindrical portion, the inner portion may have teeth bent away at a small angle for engagement with the outer side of the pipe and additionally guiding elements bent away to a greater degree, which interact with a corresponding portion of the basic body. In certain configurations, the pinching ring may be solidly fastened to the clamping ring or omitted entirely.

The clamping ring and the way in which it is guided may be differently formed. For instance, as described above, the angle between the first resting surface and the second resting surface may be smaller than the angle between the lateral surface of the rearwardly widening recess and the axis of the pipe. This has the result that, when the pipe is pulled back, the rearmost clamping edge of the profiling immediately comes into engagement with the outer side of the pipe and directly exerts a high pressing pressure on it. This is of advantage to the extent that a greater distance between the engagement of the pinching ring and the contacting by the clamping ring is consequently created. In a further preferred variant, the clamping ring has a front portion, in which the angle between the outer lateral surface of the clamping ring and the pipe axis is greater than the cone angle of the receiving location for the clamping ring, and a rear portion, in which the angle between the outer lateral surface of the clamping ring and the pipe axis is smaller than the cone angle of the receiving location. The kink-like transition takes place level with the forwardmost clamping edge (that is to say the one nearest the mouth). Suitable angles are, for example, 14° for the cone angle of the receiving location, 13.5° for the rear portion and 16° for the front portion.

With the pinching ring and the clamping ring arranged adjacent one another, a delimiting surface for the pinching ring, which limits the bending back of the pinching ring when the pipe is pulled back, may be formed on that end face of the clamping ring that contacts the pinching ring. As a result, the maximum penetration depth of the pinching ring is limited, and consequently prevents the pipe from rupturing or undergoing other undesired damage as a result of the effect of the pinching ring. To create a delimiting surface, the end face is formed in particular as a surface which runs from the outside obliquely inward in the rearward direction and limits the maximum bending angle of the pinching ring as soon as the inner portion of the pinching ring is lying on this surface.

Furthermore, a differently formed shaped packing or else—in cases of smaller pipe tolerances or higher pushing-in forces—an O-ring known per se may be used instead of the lip seal illustrated. The seal does not have to be received in a recess enclosed by the basic body but may also be inserted into a recess formed between the basic body and the screw cap. The pinching ring, the clamping ring and the shaped packing may also be received together in a single recess. In the latter cases, no further guiding surface for the pipe is present between the clamping/pinching element and the seal, so that the guidance of the pipe is undertaken by the front and rear guiding surfaces.

The basic body of the connection piece or the basic body of a fitting formed in one piece with it may be produced from metals (INOX, red brass, etc.) or else from plastics (for example PPSU) or from composite materials. The caps and sleeves may likewise be produced from metal instead of from plastic. The way in which the functions are divided between the basic body and the cap may be chosen differently than in the case of the exemplary embodiment illustrated. Moreover, a stop may be provided for the cap on the outer side of the basic body, for example in the region of the receiving location for the pinching ring. In order to ensure additional sealing dependability, the sealing element may be produced from form-swellable material, which swells when it first comes into contact with water.

To sum up, it can be stated that a connection piece which is suitable for distributing drinking water within stories, avoids a drop in pressure and is inexpensive is provided by the invention.

### LIST OF DESIGNATIONS

| | |
|---|---|
| 110 | component |
| 111 | connection piece |
| 112 | basic body |
| 113 | external thread |
| 114 | recess |
| 115 | guiding surface |
| 116 | recess |
| 117 | guiding surface |
| 118 | stop |
| 119a | portion |
| 119b | recess |
| 120, 120′, 120″ | screw cap |
| 121 | internal thread |
| 122, 122′, 122″ | guiding surface |
| 123 | recess |
| 123a | portion |
| 124 | portion |
| 125 | recess |
| 126′, 126″ | bead |
| 127″ | bead |
| 130, 130′ | clamping ring |
| 131, 131′ | profiling |
| 132′ | slit |
| 133′ | web |
| 133a′ | portion |
| 133b′ | portion |
| 134′ | camping edge |
| 135′ | stop surface |
| 140, 140′ | pinching ring |
| 141, 141′ | portion |
| 142, 142′ | portion |
| 143′ | tooth |
| 150 | lip seal |
| 151 | lip |
| 152 | indentation |
| 153 | step |
| 154 | end face |
| 156 | lip |
| 157 | groove |
| 158 | nub |
| 160 | pipe |
| 170 | sealing element |
| 170a | sealing part |
| 170b | sealing part |
| 171 | lip |
| 172 | indentation |
| 173 | step |
| 174 | end face |
| 176 | lip |
| 177 | groove |
| 178 | nub |

1. Connection piece with a first tubular part (112, 120), which can be connected in a fluid-tight manner to a second tubular part (160) of a fluid-carrying system of lines for the distribution of drinking water, wherein
a) the connection piece (111) is formed in such a way that, in the connected state, the second tubular part (160) is partially enclosed by the first tubular part (112, 120),
b) a peripheral recess (116) in which an annular sealing element (150, 170) is received is made in the first tubular part (112, 120), on an inner lateral surface contacting the second tubular part (160) in the connected state,
c) the connection piece (111) is formed in such a way that the second tubular part (160) can be connected to the first tubular part (112, 120) in the sense of a plug-in connection by pushing it into the first tubular part (112, 120) in a pushing-in direction;
characterized in that
d) the connection piece (111) is formed without a supporting nipple in such a way that an inner lateral surface of the second tubular part (160) is not contacted by the connection piece (111) in the connected state; and in that
e) the connection piece (111) has in the region of an inner lateral surface of the first tubular part a first peripheral guiding surface (122) and a second peripheral guiding surface (117), arranged behind the first guiding surface (122) with respect to an insertion opening of the connection piece (111), for the second tubular part (160), wherein the peripheral recess (116) for the annular sealing element (150, 170) is arranged between the first guiding surface (122) and the second guiding surface (117) and wherein a first axial extent of the first guiding surface (122) and a second axial extent of the second guiding surface (117) respectively make up each at least one sixth of an inside diameter of the first tubular part (112, 120), preferably at least one quarter of the inside diameter.

2. Connection piece according to claim 1, characterized in that a clamping and/or pinching element (130, 140) for axially securing the pushed-in second tubular part (160) is arranged between the first guiding surface (122) and the peripheral recess (116).

3. Connection piece according to claim 2, characterized in that the clamping and/or pinching element comprises a clamping ring (130) with a wedge-shaped cross section, which is received in a recess (123) in the first tubular part (112, 120) that widens rearwardly with respect to the insertion opening, as well as a resilient pinching ring (140), which is arranged behind the clamping ring (130).

4. Connection piece according to claim 3, characterized in that the clamping ring (130′) has substantially axially running profilings (133′) on an outer lateral surface to interact with the recess (123).

5. Connection piece according to claim 3 or 4, characterized in that the clamping ring (130′) has on an end face contacting the pinching ring (140) an inclined stop surface, which limits bending back of elements of the pinching ring (140) during the pulling back of the pushed-in second tubular part (160).

6. Connection piece according to claim 3, characterized in that the pinching ring (140) has an outer circular-ring-shaped radial portion (141) and an inwardly adjoining slit inner portion (142), wherein the inner portion (142) includes an angle of 0-70°, preferably 1-60°, particularly preferably 20-50°, with the outer portion (141).

7. Connection piece according to claim 3, characterized in that the rearwardly widening recess (123) has an angle of 1-30°, preferably 3-20°, particularly preferably 5-15°, in relation to an axis of the first tubular part (112, 120).

8. Connection piece according to claim 7, characterized in that the clamping ring (130) has a first resting surface for contacting a lateral surface of the rearwardly widening recess (123) as well as a second resting surface for contacting an outer side of the second tubular part (160) and in that the first resting surface has at least one portion in which the angle of the first resting surface to the second resting surface of the clamping ring (130) is different from the angle of the rearwardly widening recess (123) to the axis of the first tubular part (112, 120), the difference between the angles being preferably 0.1-10°, particularly preferably 0.1-5°, in particular 0.5-2°.

9. Connection piece according to claim 1, characterized in that in the region of the first guiding surface (122′) and/or a further guiding surface (115), arranged ahead of the annual sealing element, there is formed a bead-like projection for working an outer surface of the second tubular part (160) when the latter is pushed in.

10. Connection piece according to claim 1, characterized in that the annular sealing element (150, 170) is a shaped packing in the form of a lip seal, wherein the recess (116) for the annular sealing element (150, 170) preferably widens rearwardly with respect to the insertion opening and the lip seal (150, 170) has a substantially V-shaped cross section and is received with its open end face (152) in the pushing-in direction in the recess (116).

11. Connection piece according to claim 1, characterized in that the annular sealing element (170) comprises a first annular sealing part (170a) and a second annular sealing part (170b), wherein the first annular sealing part (170a) is produced from a material which has a greater hardness than the material from which the second annular sealing part (170b) is produced and wherein the first and second annular sealing parts (170a, 170b) are preferably formed in such a way that the first pipe sealing part (170a) supports the second pipe sealing part (170b) axially on both sides.

12. Connection piece according to claim 1, characterized by a cap part (120), which partially encloses the second tubular part (160) in the connected state.

13. Connection piece according to claim 12, characterized in that the first guiding surface (122) is formed in the region of an inner lateral surface of the cap part (120).

14. Connection piece according to claim 12 or 13, characterized in that the cap part (120) is releasably fastened to a basic body (112) of the connection piece (111).

15. Connection piece according to claim 14, characterized in that arranged between the cap part (120) and the basic body (112) is a tamperproof element (119, 124, 125), in particular with a predetermined breaking point, the tamperproof element (119, 124, 125) permanently indicating when release of the cap part from the basic body (112) has taken place.

16. Connection piece according to claim 15, characterized in that an external thread (113) is formed on an outer lateral surface of the basic body (112), in that an internal thread (121) is formed on an inner lateral surface of the cap part (120), wherein the cap part (120) can be screwed with its internal thread (121) onto the external thread (113) of the basic body (112), in that also formed on the outer lateral surface of the basic body (112) is an undercut region (119b), in which a tab-like portion (124) of the cap part (120) can engage when the latter is screwed on, the undercut region (119b) and the tab-like portion (124) being formed in such a way that the tab-like portion (124) breaks when the screwed-on cap part (120) is released from the basic body (112).

17. Connection piece according to claim 1, characterized by a marking, which indicates a predetermined insertion depth of the second tubular part (160)

18. Fitting comprising a connection piece (111) according to claim 1.

19. Faucet comprising a connection piece (111) according to claim 1.

20. Arrangement for distributing hot and cold water, comprising a fluid-carrying system of lines with pipes of PEx or polybutene comprising a second tubular part (160) and at least one connection piece (111), in particular according to claim 1, with the first tubular part (112, 120) of which the second tubular part (160) is connected in a fluid-tight manner, wherein
a) the connection piece (111) is formed in such a way that, in the connected state, the second tubular part (160) is partially enclosed by the first tubular part (112, 120),
b) a peripheral recess (116) in which an annular sealing element (150, 170) is received is made in the first tubular part (112, 120), on an inner lateral surface contacting the second tubular part (160) in the connected state,
c) the connection piece (111) is formed in such a way that the second tubular part (160) can be connected to the first tubular part (112, 120) in the sense of a plug-in connection by pushing it into the first tubular part (112, 120) in a pushing-in direction; and
d) the connection piece (111) is formed without a supporting nipple in such a way that an inner lateral surface of the second tubular part (160) is not contacted by the connection piece (111) in the connected state.
